(19) United States
(12) Patent Application Publication
(10) Pub. No.: US 2010/0156846 A1
(43) Pub. Date: Jun. 24, 2010

(54) SINGLE SUBSTRATE CAPACITIVE TOUCH PANEL

(75) Inventors: Ding Hua Long, Shenzhen (CN); Hai Long Zhang, Shenzhen (CN); Hai Hui Zhang, Shenzhen (CN)

Correspondence Address: MARSH, FISCHMANN & BREYFOGLE LLP, 8055 East Tufts Avenue, Suite 450, Denver, CO, 80237, US

(73) Assignee: Flextronics AP, LLC, Broomfield, CO (US)

(21) Appl. No.: 12/642,183

(22) Filed: Dec. 18, 2009

Related U.S. Application Data
(60) Provisional application No. 61/140,524, filed on Dec. 23, 2008.

(51) Int. Cl. G06F 3/041; B05D 5/12; B05D 3/06

(52) U.S. Cl. 345/174; 427/79; 216/13

(57) ABSTRACT

A touch screen sensor assembly that includes a single substrate. In one embodiment, the assembly includes a first patterned transparent conductive layer (e.g., indium tin oxide) disposed on top of the substrate. The assembly also includes a second patterned transparent conductive layer disposed over the first conductive layer, with a layer of silicon oxide disposed therebetween. The silicon oxide layer functions to electrically isolate the first and second conductive layers, thereby eliminating the need for two substrates or a single substrate having transparent conductive layers on each of its top and bottom surfaces. The assembly may also be connectable to a single, non-bifurcated flexible printed circuit operative to connect the assembly to a controller.

### CROSS-REFERENCE TO RELATED APPLICATION

This application claims priority under 35 U.S.C. 119 to U.S. Provisional Application No. 61/140,524, entitled: “Single Substrate Capacitive Touch Panel,” filed on Dec. 23, 2008, the contents of which are incorporated herein as if set forth in full.

### BACKGROUND

As computers and other electronic devices become more popular, touch-sensing systems are becoming more prevalent as a means for inputting data. For example, touch-sensing systems can be found in automatic teller machines, personal digital assistants, casino game machines, mobile phones, and numerous other applications.

Capacitive touch sensing is one of the most widely used techniques in touch screen industries. Capacitive touch sensors are mainly divided in two groups, namely, continuous capacitive sensors and discontinuous (patterned) capacitive sensors. In a continuous capacitive sensor, the sensor includes a sheet of conducting thin film that is electrically excited from four corners of the touch screen. The signals induced by a user's touch are transmitted from the four corners to a controller, where they are decoded and translated into coordinates. In a typical patterned capacitive touch screen, the sensor may include one or more series of parallel conductive bars that are driven from one or both ends with an excitation signal from a controller coupled to the conductive bars through lead lines. The signals induced by a user's touch may be transmitted to the controller with the same lead lines that excite the sensor bars. These signals may then be decoded in the controller and the touch coordinates may be reported to a computer.

Touch sensors utilizing more than one patterned sensing layer are often used to determine the coordinates of a touch with high accuracy, provided that the sensing layers have a suitable pattern geometry. One example of a touch screen assembly 10 that includes two patterned conductive layers 12 and 14 is shown in FIG. 1A and FIG. 1B. The patterned conductive layers 12 and 14 may be made from a transparent conductive material, such as indium tin oxide (ITO), and each layer is generally disposed on a transparent substrate (not shown here). Each row of conducting elements of each of the sensor layers 12 and 14 includes a series of diamond-shaped electrodes that are connected to each other with short strips of relatively narrow rectangles. A dielectric layer 16 separates the two conductive layers 12 and 14, and serves to prevent them from coming into direct contact with each other. As an example the dielectric layer 16 may include an adhesive manufactured from any non-conductive, transparent material.

As shown, the end of each row of the two patterned conductive layers 12 and 14 is coupled to one of a set of traces 18 (e.g., silver traces) that are in turn coupled to a controller 20. Generally, the traces 18 are used to couple the electrodes to the controller 20 because the resistance of the ITO conductive layer is relatively high. The resistance of the ITO conductive layer is relatively high because the amount of conductive material used in the ITO compound must be kept relatively low so that the layer is substantially transparent. The traces 18 may generally be deposited on to the substrate using any suitable process. One method includes vacuum sputtering a metal layer (e.g., aluminum or Mo—Al—Mo) onto the substrate, then etching the traces 18 using a photo etching process. Another method includes silk-screen printing silver conductive ink to form the traces 18.

The controller 20 may include circuitry for providing excitation currents to the capacitive sensors 12 and 14 and for detecting signals generated by the sensors. Further, the controller 20 may include logic for processing the signals and conveying touch information to another part of an electronic device, such as a processor.

FIG. 2 illustrates the various layers that may be included in a touch screen sensor assembly 40. The assembly 40 includes a top substrate 42a and a bottom substrate 42b that are each coated with patterned ITO layers 44a and 44b, respectively, that include a plurality of electrodes. The substrates 42a and 42b may be configured from any suitable transparent material, including glass, plastic (e.g., PET), or the like. Further, the top ITO layer 44a may be laminated to the bottom ITO layer 44b by a suitable dielectric spacer 48 that is adhered by optically clear adhesive layers 46a and 46b.

As discussed above, the ITO layers 44a and 44b may be coupled to one or more controllers that are operable to excite and sense electrical signals on the electrodes of the ITO layers 44a and 44b. To electrically connect the controller to the ITO layers 44a and 44b, a flexible printed circuit (FPC) 56 may be coupled to the assembly 40. The FPC 56 may include an FPC substrate 55, top copper traces 54a, and bottom copper traces 54b that are used to couple the top and bottom ITO layers 44a and 44b to a controller. To make the connection between the copper traces 54a and 54b and the ITO layers 44a and 44b, traces 50a and 50b may be disposed in contact with portions of the ITO layers. Further, the traces 50a and 50b may be coupled to the copper traces 54a and 54b using electrically conducive adhesive layers 52a and 52b, which may, for example, include an anisotropic conductive adhesive (ACA).

FIG. 3 illustrates various layers that may be incorporated into another touch sensor assembly 51. In the assembly 51, only a single substrate 53 is used and it includes patterned ITO layers 57a-b disposed on the top and bottom surfaces of the substrate 53. To couple the ITO layers 57a-b to a controller, traces 58a-b may be configured on the substrate 53 (e.g., by screen printing) such that the traces 58a-b may be bonded to FPC connectors 59a-b. As shown, since the traces 58a-b are vertically spaced apart from each other, two FPC connectors 59a-b (or a single bifurcated FPC connector) are required to couple the ITO layers 57a-b to a controller. As can be appreciated, the need for two FPC connectors or a bifurcated FPC connector may substantially increase the complexity of the manufacturing process.

### SUMMARY

Disclosed herein is a patterned substrate for a touch screen sensor assembly including a base substrate, a first transparent conductive layer deposited on a first side of the base substrate and forming a pattern of electrodes, a silicon oxide layer deposited over the first transparent conductive layer, and a second transparent conductive layer deposited over the silicon oxide layer and forming a pattern of electrodes. The first transparent conductive layer is electrically isolated from the second transparent conductive layer by the silicon oxide layer.

The silicon oxide layer may include silicon dioxide. The patterned substrate may further include a plurality of traces disposed on the base substrate that are each electrically coupled to one or more of the electrodes. A connector may be electrically coupled to the plurality of traces. For instance, the connector may be a single, non-bifurcated flexible printed circuit. The traces may be formed from silver. The first and second transparent conductive layers may include indium tin oxide (ITO). The base substrate may be formed from glass and/or plastic.

Also disclosed herein is a method for manufacturing a substrate for a touch screen sensor assembly. The method includes providing a base substrate, depositing a first transparent conductive layer over the base substrate that includes a first pattern of electrodes, depositing a silicon oxide layer over the first conductive layer, and depositing a second transparent conductive layer over the silicon oxide layer that includes a second pattern of electrodes. The first transparent conductive layer is electrically isolated from the second transparent conductive layer by the silicon oxide layer.

The method may include removing portions of the first transparent conductive layer from the base substrate to form the first pattern of electrodes and removing portions of the second transparent conductive layer to form the second pattern of electrodes. A plurality of traces may be deposited on the base substrate, wherein each of the plurality of traces is electrically coupled to at least one electrode of the first and/or second pattern of electrodes. A connector may be bonded to the plurality of traces. The removing of portions of the first and second transparent conductive layers may include using a photo etching process.

Also disclosed herein is a patterned substrate for a touch screen sensor assembly including a base substrate, a plurality of transparent conductive portions deposited over a first side of the base substrate, a plurality of transparent non-conductive portions each of which is deposited over a portion of one of the plurality of transparent conductive portions, and a grid including a plurality of conductive rows and a plurality of conductive columns. Each conductive row is deposited over at least one of the transparent non-conductive portions and each conductive column is deposited over at least one of the transparent conductive portions. The plurality of conductive rows are electrically isolated from the plurality of conductive columns by the plurality of transparent non-conductive portions.

Each of the plurality of conductive rows and plurality of conductive columns may include a plurality of electrodes. Each of the plurality of conductive rows may include a plurality of interconnection portions each of which electrically interconnects at least two electrodes in a respective conductive row. Each associated transparent non-conductive and conductive portion may make up an “isolation region” such that each interconnection portion is deposited over the transparent non-conductive portion of one of the isolation regions. Each associated transparent non-conductive and conductive portion may up an “isolation region” whereby each of the electrodes of the plurality of conductive columns includes at least one contact portion that is deposited over the transparent conductive portion of one of the isolation regions. The at least one contact portion may be deposited over the transparent non-conductive portion of the one of the isolation regions.

The patterned substrate may further include a plurality of traces disposed on the base substrate that are each electrically coupled to one or more of the electrodes. The patterned substrate may further include a connecter that is electrically coupled to the plurality of traces. The electrodes of the plurality of conductive rows and the electrodes of the plurality of conductive columns may at least generally reside in a single plane. The patterned substrate may further include a plurality of traces disposed on the base substrate wherein at least some of the traces may each by electrically coupled to one or more of the electrodes of the plurality of conductive rows and at least some of the traces may each be electrically coupled to one or more of the electrodes of the plurality of conductive columns. The some of the traces electrically coupled to one or more of the electrodes of the plurality of conductive rows and plurality of conductive columns may at least generally reside in the single plane. The plurality of conductive rows may not be in contact with the plurality of conductive columns or the plurality of transparent conductive portions.

Also disclosed herein is a method for manufacturing a substrate for a touch screen sensor assembly including providing a base substrate, forming a plurality of transparent conductive portions on a first side of the base substrate, forming a plurality of transparent non-conductive portions on the plurality of transparent conductive portions such that each transparent non-conductive portion is deposited over a portion of one of the plurality of transparent conductive portions, and forming a grid over the base substrate and the plurality of transparent conductive and non-conductive portions that includes a plurality of conductive rows and a plurality of conductive columns. Each conductive row is in contact with at least one of the transparent non-conductive portions and each conductive column is in contact with at least one of the transparent conductive portions. The plurality of conductive rows are electrically isolated from the plurality of conductive columns by the plurality of transparent non-conductive portions.

At least one of the forming a plurality of transparent conductive portions, forming a plurality of transparent non-conductive portions, and forming a grid steps may include depositing a layer over the base substrate and removing portions of the layer from the base substrate to form the at least one of the plurality of transparent conductive portions, plurality of transparent non-conductive portions, and grid. The method may further include depositing a plurality of traces on the base substrate each of which is electrically coupled to at least one of the plurality of conductive rows and plurality of conductive rows. A protective layer may be coated over the grid. A connector may be bonded to the plurality of traces. The plurality of conductive rows may not be in contact with the plurality of conductive columns or the plurality of transparent conductive portions.

Also disclosed herein is a patterned substrate for a touch screen sensor assembly including a base substrate, at least one row of electrodes deposited over a first side of the base substrate wherein adjacent electrodes in the at least one row of electrodes are interconnected by a leg portion, at least one column of electrodes deposited over the first side of the base substrate, and a transparent non-conductive layer disposed between the base substrate and at least one of the at least one row of electrodes and the at least one column of electrodes. The at least one row of electrodes is electrically isolated from the at least one column of electrodes.

The at least one row of electrodes may generally reside in a first plane and the at least one column of electrodes may generally reside in a second plane different from the first plane. The transparent non-conductive layer may generally reside in a third plane that is disposed between the first and second planes.

The at least one row of electrodes and the at least one column of electrodes may generally reside in a single plane. The transparent non-conductive layer may be disposed between the base substrate and the leg portion of adjacent electrodes in the at least one row of electrodes. A transparent conductive layer may be disposed between the transparent non-conductive layer and the base substrate. Adjacent electrodes in the at least one column of electrodes may be electrically interconnected to the transparent conductive layer. Adjacent electrodes in the at least one column of electrodes may be in contact with the transparent non-conductive layer.

### BRIEF DESCRIPTION OF THE DRAWINGS

FIGS. 1A and 1B illustrate a top view and cross-sectional view of a prior art capacitive touch sensor assembly.

FIG. 2 illustrates the configuration of various layers for a prior art touch screen sensor assembly.

FIG. 3 illustrates the configuration of various layers for a prior art touch screen sensor assembly.

FIG. 4 illustrates an electronic device that incorporates an exemplary touch screen sensor assembly.

FIG. 5 illustrates an automatic teller machine that incorporates an exemplary touch screen assembly.

FIGS. 6-12 illustrate process steps for manufacturing a touch screen sensory assembly according to one embodiment.

FIGS. 13-19 illustrate process steps for manufacturing a touch screen sensor assembly according to another embodiment.

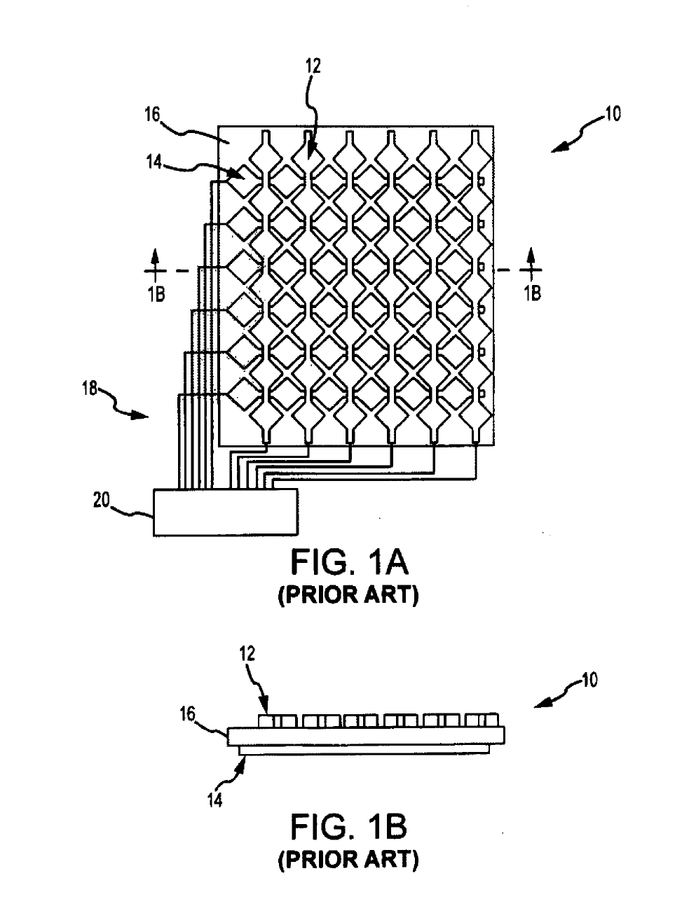

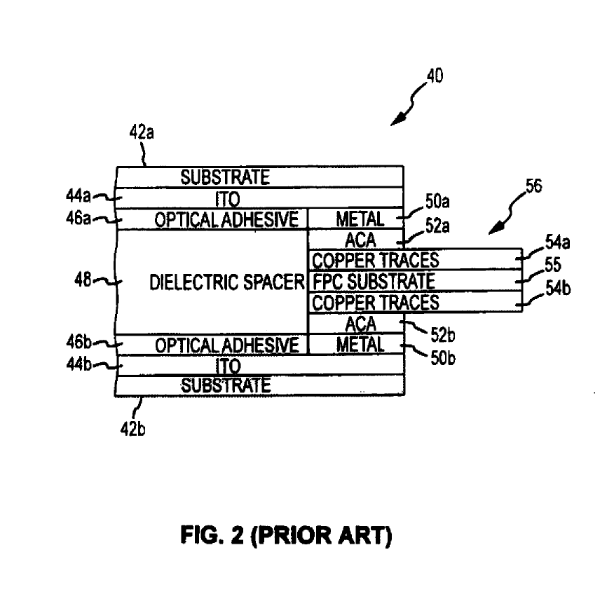

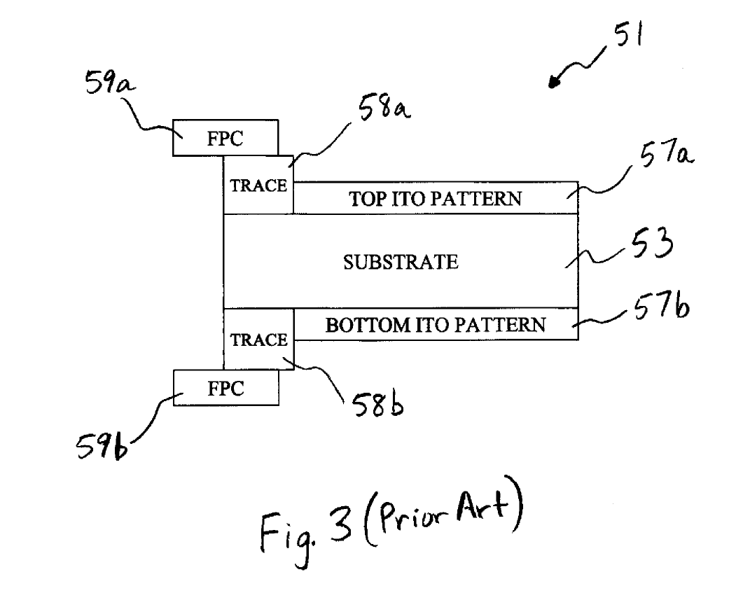

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

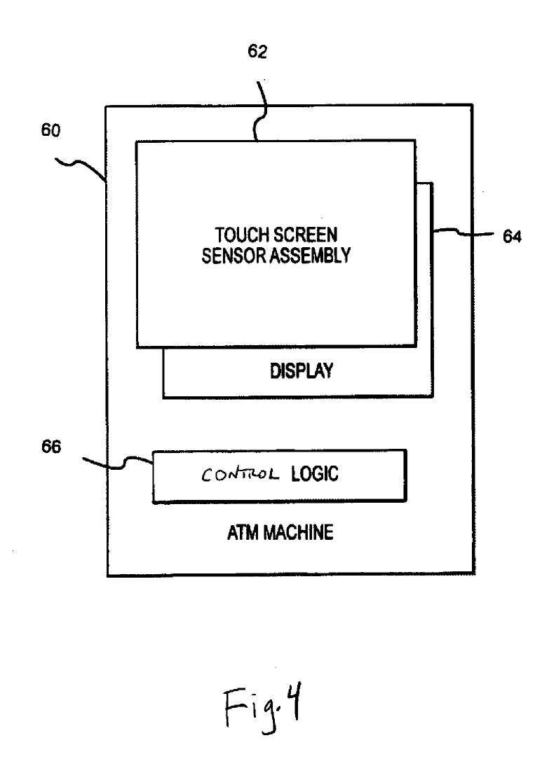

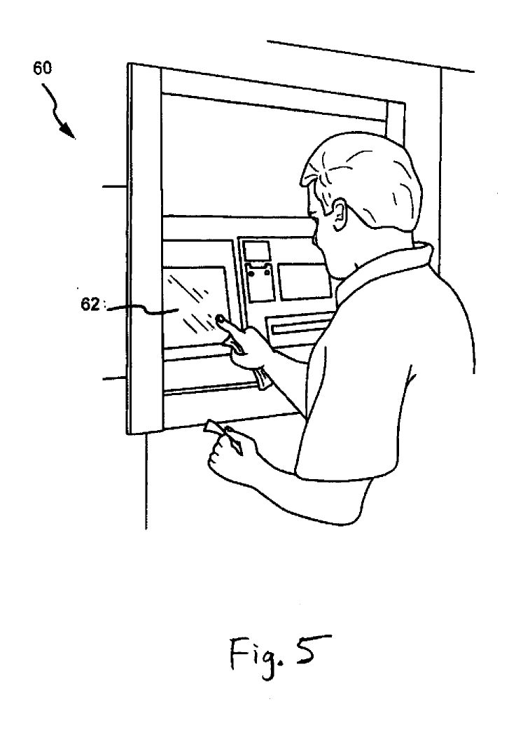

FIGS. 4 and 5 illustrate an automated teller machine (ATM) 60 that incorporates an exemplary touch screen sensor assembly 62. Although the ATM 60 is illustrated, the embodiments described herein may be incorporated into any electronic device that includes a touch screen, such as a personal digital assistant (PDA), a casino game machine, a mobile phone, a computer, a voting machine, or any other electronic device. The touch screen sensor assembly 62 may include two layers of transparent patterned conductive material (may also be called “resistive” material), such as a non-metallic ceramic like ITO, that are positioned in a spaced, parallel relationship. The touch screen sensor assembly 62 may also be coupled to control logic 66 (shown in FIG. 4) that is operable to excite the conductive material and to sense touches on or near the touch screen sensor assembly 62. As an example, the control logic 66 may include a commercial touch screen controller (e.g., a controller provided by Cypress Semiconductor, Analog Devices, Atmel, Synaptics, and others), an application specific integrated circuit (ASIC), or any other suitable controller. Further, the touch sensor assembly 62 may overlay a display 64 (shown in FIG. 4), which may be any type of display, such as an LCD display.

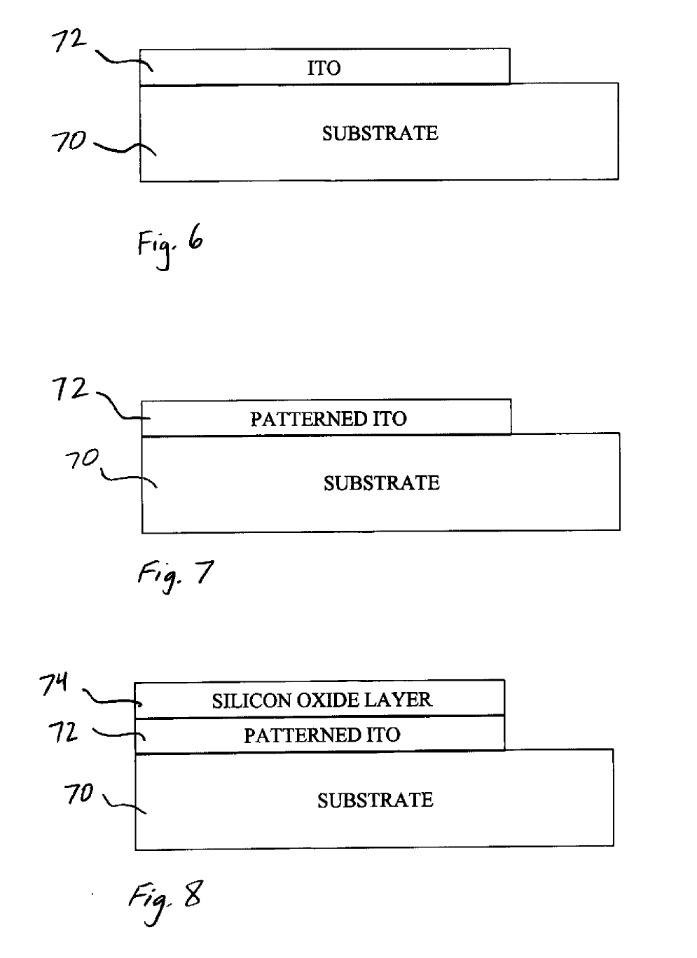

FIGS. 6-12 illustrate cross-sectional side views of an ITO patterned substrate 68 in various sequential stages of one embodiment of a manufacturing process. The substrate 68 may be included in a touch screen sensor assembly (e.g., the touch screen sensor assembly 62 shown in FIGS. 4-5). Throughout FIGS. 6-12, similar or identical elements are indicated by the same reference numerals. Further, the relative shapes and sizes of each of the elements are not necessarily to scale, but rather the figures provide illustrations of the relationship of the various layers of a touch screen sensor assembly.

FIG. 6 shows a base substrate 70 of the ITO patterned substrate 68 after it has been coated with a bottom ITO layer 72 that has been deposited onto the base substrate 70 using any suitable process, such as vacuum sputtering. Generally, the bottom ITO layer 72 may be coated on the base substrate 70 in areas that correspond to a viewing area of a display. Further, the base substrate 70 may be formed from any suitable material, including glass, plastic (e.g., PET), or other material.

FIG. 7 illustrates the next step in the manufacturing process, which is to form a pattern of electrodes (e.g., rows or columns) by any appropriate process such as by removing (e.g., by photo etching) portions of the bottom ITO layer 72 from portions of the base substrate 70. The electrodes of the bottom ITO layer 72 may generally reside in a first plane. It should be appreciated that the bottom ITO layer 72 may be formed into any suitable pattern that may be desirable for a touch screen sensor assembly.

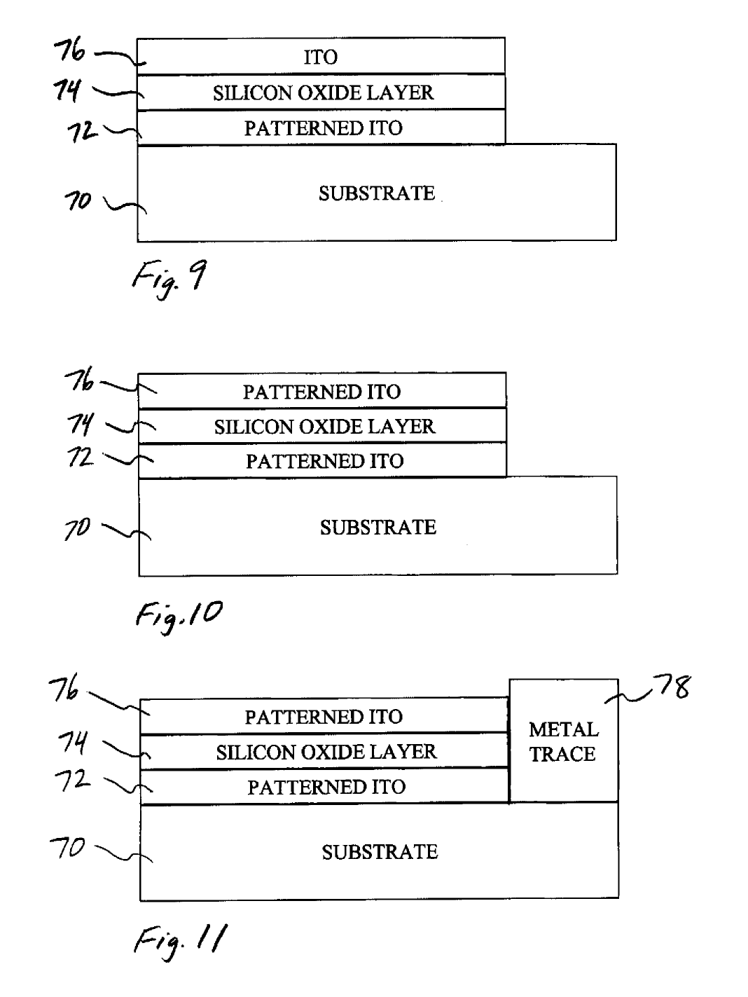

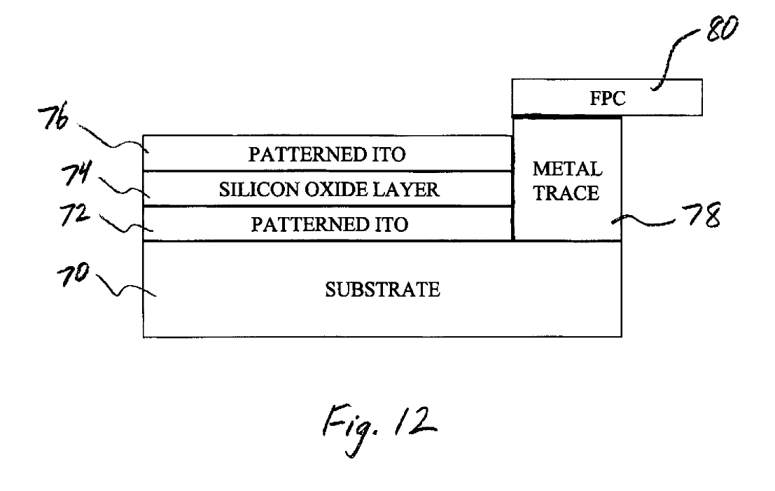

FIG. 8 illustrates the next step in the manufacturing process, which is to coat a non-conductive layer such as a silicon oxide (e.g., silicon dioxide) layer 74 over the patterned bottom ITO layer 72. The silicon oxide layer 74 functions to electrically isolate the patterned bottom ITO layer 72 from a top ITO layer 76 (shown in FIG. 9). In this regard, the need for a second substrate coated with an ITO pattern has been eliminated or at least reduced. Further, both the top and bottom ITO layers 72 and 76 are disposed on a single side of the base substrate 70, rather than on the top and bottom surfaces of the substrate. This feature greatly simplifies the manufacturing process by allowing a single, non-bifurcated FPC connector to be used.

FIG. 9 shows the substrate 68 after the next step in the manufacturing process, wherein the top ITO layer 76 has been deposited over the electrically isolating silicon oxide layer 74. Similar to the bottom ITO layer 72, the top ITO layer 76 may be deposited using any suitable process, such as vacuum sputtering.

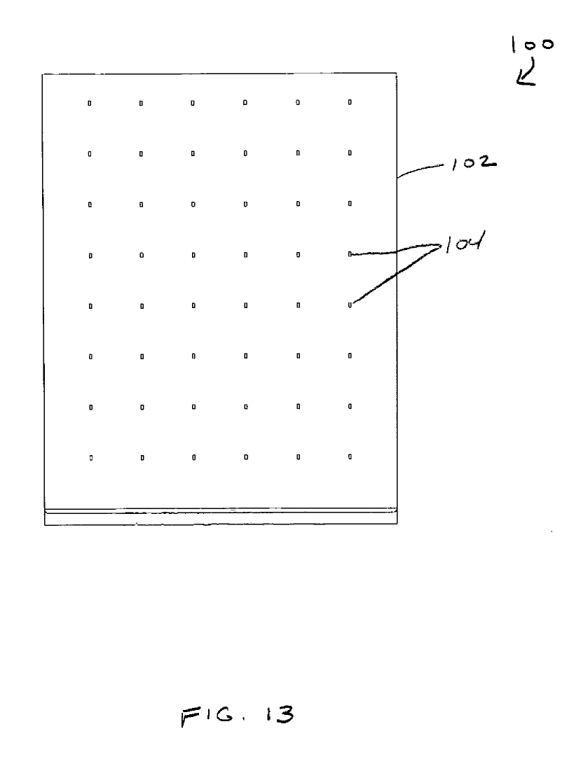

FIG. 10 illustrates the next step in the manufacturing process, which is to form a pattern of electrodes (e.g., rows or columns) by any appropriate process such as by removing (e.g., by photo etching) portions of the top ITO layer 76. The electrodes of the top ITO layer 76 may generally reside in a second plane such and the silicon oxide layer 74 may generally reside in a third plane such that the third plane may be disposed between the first and second planes. It should be appreciated that the top ITO layer 76 may be formed into any suitable pattern that may be desirable for a touch screen sensor assembly. For example, the top ITO layer 76 may be patterned into a set of rows of electrodes and the bottom ITO layer 72 may be patterned into a set of columns of electrodes to form a “crisscross” pattern.

FIG. 11 illustrates the next step of the manufacturing process, which is to deposit traces 78 onto the base substrate 70 in a manner such that the traces 78 are electrically coupled to the electrodes of the top and bottom ITO layers 72 and 76. The traces 78 may be formed from any material, such as silver, Mo—Al—Mo, another metal, or any other suitable material. The traces 78 may generally be deposited on to the substrate using any suitable process. One method includes vacuum sputtering a metal layer (e.g., aluminum or Mo—Al—Mo) onto the substrate, then etching the traces 78 using a photo etching process. Another method includes silk-screen printing silver conductive ink on the base substrate 70 to form the traces 78. The traces 78 may be routed near the edges of the substrate outside of the viewing area so that the electrodes of the ITO layers 72 and 76 may be coupled to a controller.

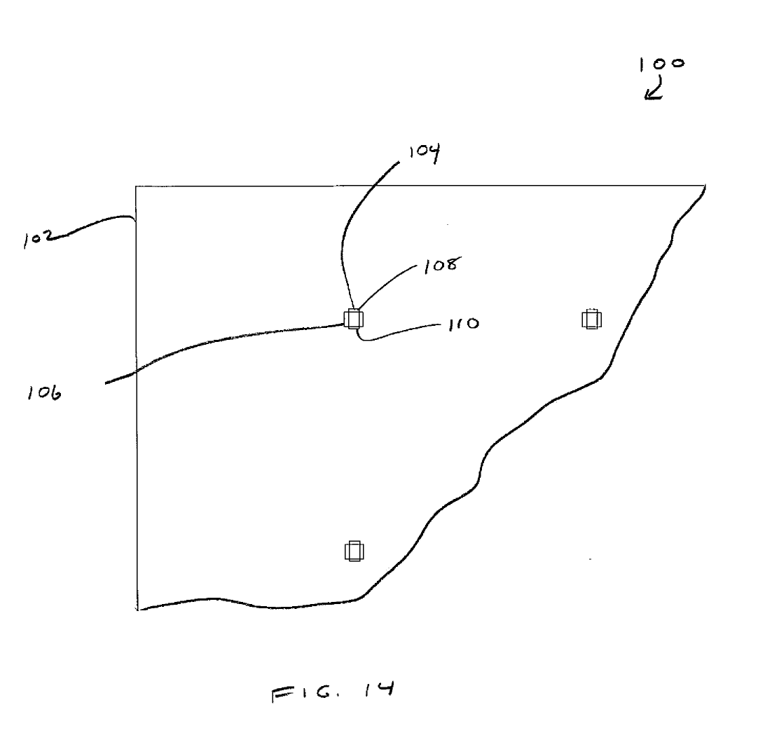

FIG. 12 illustrates the ITO patterned substrate 68 after the next step of the manufacturing process, which is to bond a connector such as a flexible printed circuit (FPC) connector 80 to the traces 78, so that the ITO layers 72 and 76 may be coupled to a controller in a fully assembled touch screen sensor assembly. The FPC connector 80 may be bonded to the traces 78 using any suitable material, such as an anisotropic conductive adhesive (ACA). As shown, since the traces 78 are positioned on a single side of the base substrate 70, a single, non-bifurcated FPC connector may be used to couple the electrodes to a controller. Further, although not shown, additional layers may be included when formed into a fully assembled touch screen sensor assembly. For example, one or more protective layers may be disposed over the top ITO layer 76 to protect the layer from damage that may be caused by a user's fingers, a stylus, the weather, or other potentially damaging actions or effects.

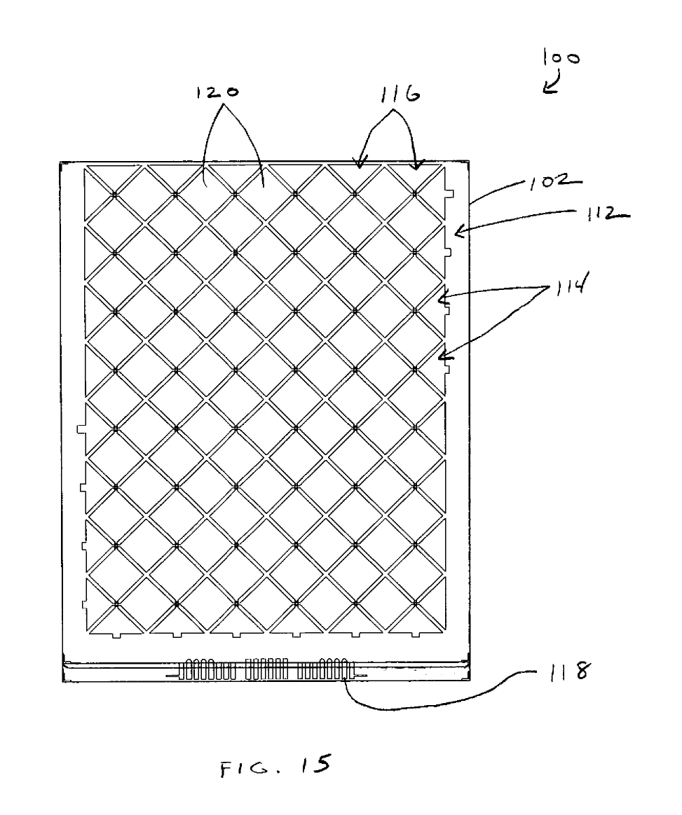

As illustrated in FIGS. 13-18, plan views of various sequential stages of another embodiment of a manufacturing process of a patterned substrate 100 are shown. The patterned substrate 100 may be included in a touch screen sensor assembly (e.g., the touch screen sensor assembly 62 shown in FIGS. 4-5). It should be appreciated that the relative shapes and sizes of each of the elements are not necessarily to scale and that the figures are intended to provide illustrations of the relationship of the various layers of a touch screen sensor assembly.

FIG. 13 shows a plan view of a base substrate 102 constructed of any appropriate material (e.g., glass, plastic, PET) after a plurality of transparent conductive portions 104 (e.g., ITO portions or layers) have been appropriately formed on a first side of the base substrate 102. The conductive portions 104 may be of any appropriate shape (e.g., rectangular, square) and/or thickness and may be spaced apart from each other in any appropriate pattern on the base substrate 102. For instance, an ITO layer may be deposited onto the base substrate 102 using any suitable process (e.g., vacuum sputtering) over areas that correspond to a viewing area of a display. Thereafter, the conductive portions 104 may be formed by removing portions of the ITO layer from the base substrate 102 using any appropriate process (e.g., photo etching). It should be appreciated that the plurality of conductive portions 104 may be formed into any suitable pattern that may be desirable for a touch screen sensor assembly.

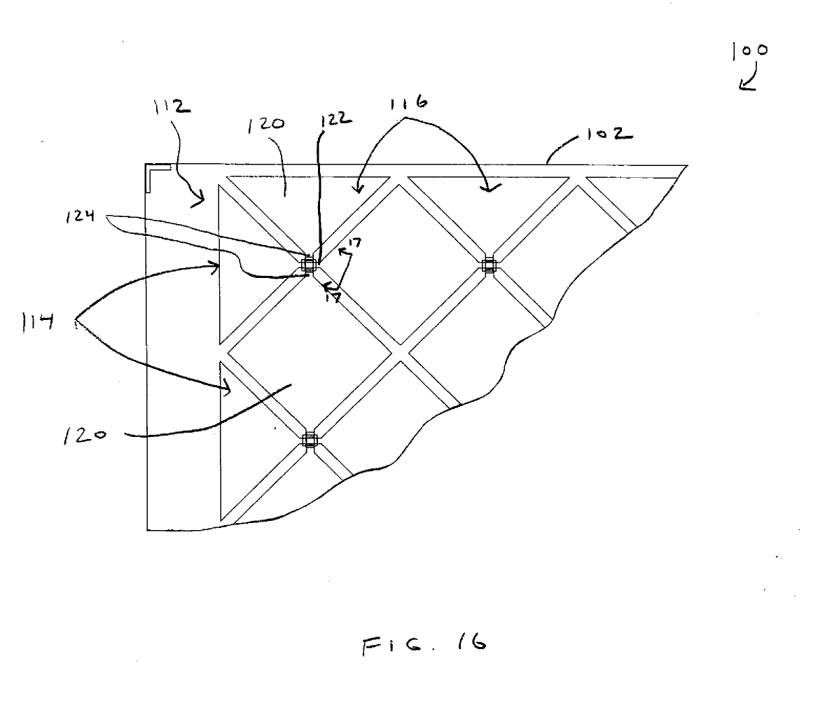

FIG. 14 illustrates a close-up plan view of a top left portion of the base substrate 102 and represents the result of a next step in the manufacturing process. As shown, a plurality of transparent non-conductive or insulative portions 106 have been deposited or otherwise formed over each of the conductive portions 104 in a manner such that opposite first and second portions 108, 110 of each conductive portion 102 protrude from each corresponding non-conductive portion 106 and are thereby exposed. As will be more fully discussed below, this arrangement will allow each subsequently formed conductive row (not shown in FIG. 14) to be electrically isolated from each subsequently formed conductive column (also not shown in FIG. 14). Each of the non-conductive portions 106 may be formed of a silicon oxide portion or layer (e.g., silicon dioxide) that has been appropriately deposited over each corresponding conductive portion 102. For instance, a layer of silicon dioxide may be deposited over the base substrate 102 and the conductive portions 104 using any suitable process (e.g., vacuum sputtering), and then the non-conductive portions 106 may be formed by removing portions of the silicon dioxide layer using any appropriate process (e.g., photo etching).

Turning now to FIGS. 15-17, the result of a next step in the manufacturing process is shown whereby a conductive grid 112 (e.g., electrode pattern or array) may be formed over the base substrate 102 and the previously formed conductive and non-conductive portions 104, 106. Particularly, FIG. 15 is a plan view of the patterned substrate 100 illustrating how the conductive grid 112 may include a series of conductive rows 114 interspersed among and between a series of conductive columns 116, such that the rows and columns 114, 116 are included on at least a substantial portion of a viewing area of a display that incorporates the ITO patterned substrate 100 (e.g., to form a “crisscross pattern”). It should be appreciated that “columns” and “rows” may be used interchangeably and are only meant to connote conductive members or elements extending along different directions.

Also as part of this step in the manufacturing process, a series of contacts 118 may be formed on any convenient portion (e.g., bottom) of the base substrate 102. As will be discussed in more detail below, each of the contacts 118 may be operable to enact an electrical connection between a trace (not shown in FIG. 15) and a flexible printed circuit (FPC) connector to ultimately allow current to flow between a controller and one of the rows or columns 114, 116. As with previous layers, the conductive grid 112 and contacts 118 may be formed by depositing a conductive layer or layers (e.g., ITO layer) over the base substrate 102 using any suitable process (e.g., vacuum sputtering) and then removing portions of the ITO layer using any appropriate process (e.g., photo etching) to reveal the rows, columns, and contacts 114, 116, 118. Each row and column 114, 116 may be in the form of a series of diamond, triangular, or other shaped electrodes 120. As will be appreciated and more fully described below, a majority of the electrodes 120 of the rows and columns 114, 116 reside in a single plane.

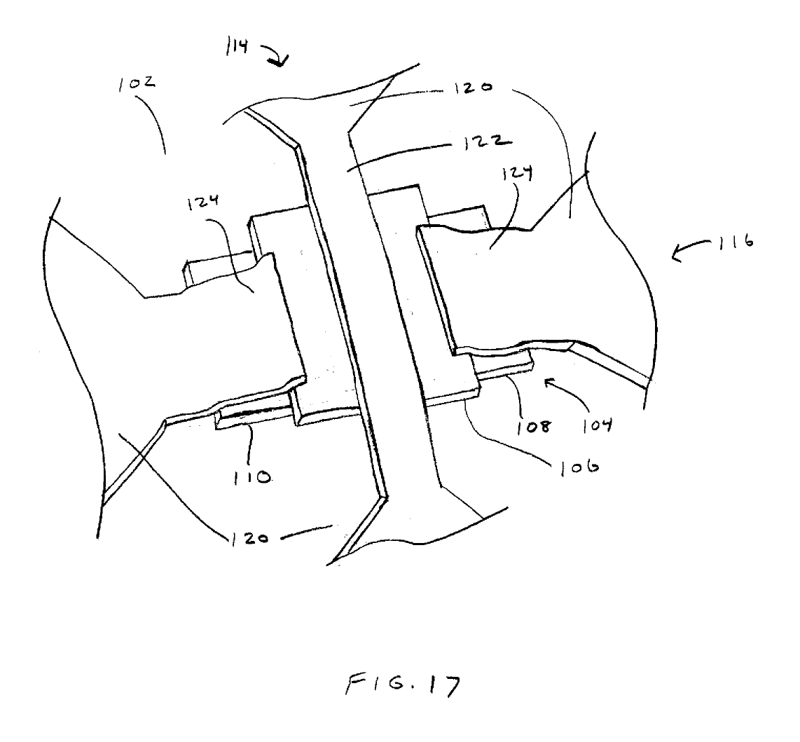

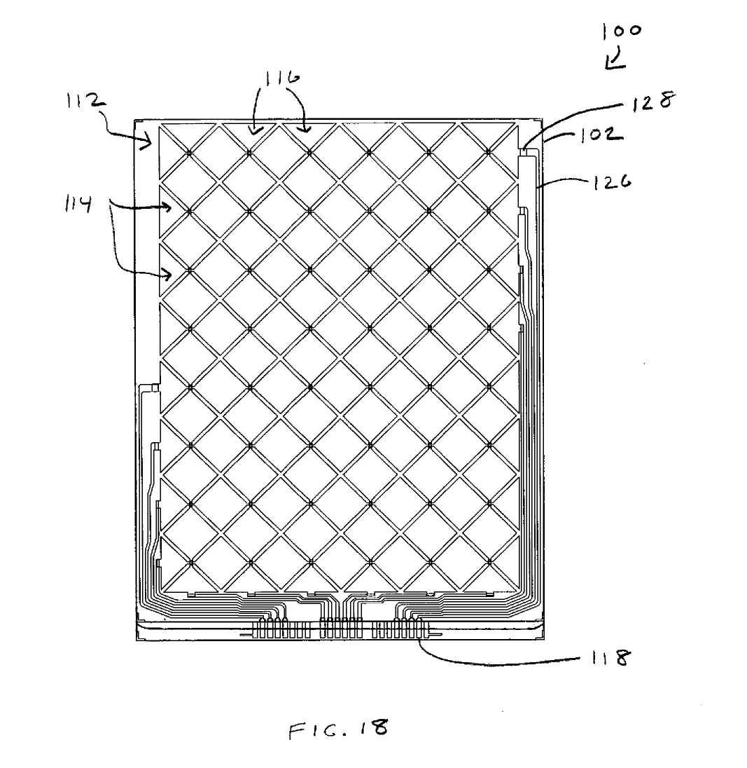

FIG. 16 is a plan view of a top left portion of the conductive grid 112 where the conductive grid 112 overlaps a respective conductive and non-conductive portion 104, 106 (hereinafter an “isolation region”), and FIG. 17 is a close-up perspective view of the isolation region in the direction of lines 17-17. As shown, adjacent electrodes 120 of each row 114 may be electrically interconnected by a leg or interconnection portion 122 that may be integrally formed with the electrodes of each row 114 as part of the manufacturing process step that forms the conductive grid 112. Each interconnection portion 122 may be deposited or otherwise formed over each respective non-conductive portion 106 such that the interconnection portion 112 and thus each entire row 114 is electrically isolated from the plurality of conductive portions 104.

Turning now to the columns 116, each electrode 120 of each column 116 may include first and second opposed contact portions 124, except for some of those electrodes 120 adjacent a perimeter of the base substrate 102 which may have only a single electrode 120. Each contact portion 124 may be deposited or otherwise formed during the manufacturing process to overlay or otherwise lay in electrical contact with a portion of a respective conductive portion 104, and in some embodiments a portion of a respective conductive portion 104 and a corresponding non-conductive portion 106.

For instance and with particular reference to FIG. 17, a contact portion 124 of a first electrode 120 of a column 116 may be in contact with both a non-conductive portion 106 and a first portion 108 of a conductive portion 104, and a contact portion 124 of an adjacent second electrode 120 may be in contact with the non-conductive portion 106 and a second portion 110 of the conductive portion 104. Each electrode 120 of each column 116 will thus be electrically interconnected to an adjacent electrode of the column 116 by way of the respective conductive portion 104. However, the electrodes 120 of the columns 116 are formed so as to not be in electrical contact with the electrodes 120 of the rows 114, and the non-conductive portions 106 further serve to prevent or reduce the chances of electrical contact between the electrodes 120 of the columns 116 from the electrodes 120 of the rows 114. The resulting arrangement allows the rows 114 to be electrically isolated from the columns 116 by way of one or more dielectrics (e.g., the non-conductive portions 106) thus forming a grid of capacitors. Furthermore, manufacturing efficiency can be enhanced as electrodes of the rows and columns 114, 116 can be etched or otherwise formed in a single step and touch screen panel transparency can be increased as the quantity of dielectric material utilized can be reduced. It should be appreciated that the various components illustrated in FIG. 17 have been exaggerated for clarity and may assume any appropriate dimensions, shapes and the like.

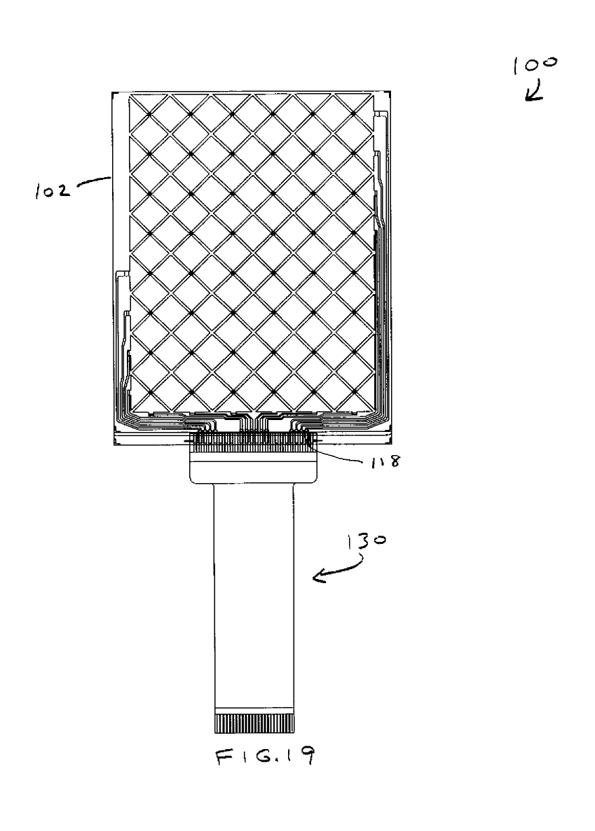

With reference now to FIG. 18, a plan view of the patterned substrate 100 is illustrated after a next step in the manufacturing process. Particularly, a plurality of traces 126 (e.g., formed of those materials as previously described) has been deposited or otherwise formed onto the base substrate 102 (e.g., in a manner as previously described) such that at least one trace 126 is electrically coupled to and between one of the rows or columns 114, 116 and one of the contacts 118. For instance, at least one electrode 120 in each row and column 114, 116 near a perimeter of the base substrate 102 may include a contact portion 128 for electrical interconnection to a respective trace 126. During manufacture, each trace 126 may be formed so as to overlie a contact portion 128 and a contact 118 and thus allow current to flow from a controller (not shown) and through an FPC board (not shown), contact 118 and trace 126 and eventually to the electrodes 120. Although not illustrated, any appropriate covering(s) or layer(s) may be deposited, coated, formed or otherwise positioned over the rows and columns 114, 116 to protect or shield the patterned substrate 100 from damage that may be caused by a user's fingers, a stylus, the weather, or other potentially damaging actions or effects.

FIG. 19 illustrates a plan view of the patterned substrate 100 after an FPC connector 130 has been appropriately positioned over and electrically bonded to the contacts 118. In this regard, the rows and columns 114, 116 of the conductive grid 112 may be electrically coupled to a controller (not shown) in a fully assembled touch screen sensor assembly by way of the FPC connector 130 and the traces 126. The FPC connector 130 may be bonded to the contacts 118 using any suitable material, such as an anisotropic conductive adhesive (ACA). Moreover, the FPC connector 130 may advantageously be in the form of a single, non-bifurcated FPC connector because the electrodes 120 of the rows and columns 114, 116, the traces 126 and the contacts 118 reside substantially in a single plane.

The features described herein offer several advantages over previous designs. For example, using a single substrate instead of two substrates eliminates the need for laminating two substrates together with an optically clear adhesive (OCA). This lamination process can be a difficult one in which bubbles may be formed in the touch sensor assembly, thereby undesirably reducing the yield of the manufacturing process. Further, the prior art designs that include a single substrate with ITO patterned electrodes on the top and bottom surfaces of the substrate also have manufacturing difficulties. As noted above, when the traces used to couple the electrodes to a controller are positioned on opposite sides of a single substrate, there is a need for two FPC connectors (or a bifurcated FPC connector) because the traces are not positioned in the same plane. Additionally, it can be difficult to dispose patterned ITO layers on both the top and bottom surfaces of a substrate because after the first surface has been patterned there is a need to provide protection for that patterned surface while the second surface is patterned. This protection requirement can greatly increase the complexity of the manufacturing process. As can be appreciated, many of the above-noted shortcomings of the previous designs are overcome by the touch screen sensor assemblies described herein.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed:

1. A patterned substrate for a touch screen sensor assembly, the patterned substrate comprising;
a base substrate;
a first transparent conductive layer deposited on a first side of the base substrate, the first transparent conductive layer forming a pattern of electrodes;
a silicon oxide layer deposited over the first transparent conductive layer; and
a second transparent conductive layer deposited over the silicon oxide layer, the second transparent conductive layer forming a pattern of electrodes;
wherein the first transparent conductive layer is electrically isolated from the second transparent conductive layer by the silicon oxide layer.

2. The patterned substrate of claim 1, wherein the silicon oxide layer includes silicon dioxide.

3. The patterned substrate of claim 1, further comprising:
a plurality of traces disposed on the base substrate that are each electrically coupled to one or more of the electrodes.

4. The patterned substrate of claim 3, further comprising:
a connecter that is electrically coupled to the plurality of traces.

5. The patterned substrate of claim 4, wherein the connector is a single, non-bifurcated flexible printed circuit.

6. The patterned substrate of claim 3, wherein the plurality of traces are formed from silver.

7. The patterned substrate of claim 1, wherein the first and second transparent conductive layers include indium tin oxide (ITO).

8. The patterned substrate of claim 1, wherein the base substrate is formed from glass.

9. The patterned substrate of claim 1, wherein the base substrate is formed from plastic.

10. A method for manufacturing a substrate for a touch screen sensor assembly, the method comprising:
providing a base substrate;
depositing a first transparent conductive layer over the base substrate, the first transparent conductive layer including a first pattern of electrodes;
depositing a silicon oxide layer over the first conductive layer; and
depositing a second transparent conductive layer over the silicon oxide layer, the second transparent conductive layer including a second pattern of electrodes, wherein the first transparent conductive layer is electrically isolated from the second transparent conductive layer by the silicon oxide layer.

11. The method of claim 10, further comprising:
removing portions of the first transparent conductive layer from the base substrate to form the first pattern of electrodes; and
removing portions of the second transparent conductive layer to form the second pattern of electrodes

12. The method of claim 11, further comprising:
depositing a plurality of traces on the base substrate, wherein each of the plurality of traces is electrically coupled to at least one electrode of the first and/or second pattern of electrodes.

13. The method of claim 12, further comprising:
bonding a connector to the plurality of traces.

14. The method of claim 11, wherein the removing of portions of the first and second transparent conductive layers comprises using a photo etching process.

15. A patterned substrate for a touch screen sensor assembly, the patterned substrate comprising;
a base substrate;
a plurality of transparent conductive portions deposited over a first side of the base substrate;
a plurality of transparent non-conductive portions, each transparent non-conductive portion being deposited over a portion of one of the plurality of transparent conductive portions; and
a grid comprising a plurality of conductive rows and a plurality of conductive columns, wherein each conductive row is deposited over at least one of the transparent non-conductive portions and each conductive column is deposited over at least one of the transparent conductive portions, and wherein the plurality of conductive rows are electrically isolated from the plurality of conductive columns by the plurality of transparent non-conductive portions.

16. The patterned substrate of claim 15, wherein each of the plurality of conductive rows and plurality of conductive columns comprises a plurality of electrodes.

17. The patterned substrate of claim 16, wherein each of the plurality of conductive rows comprises a plurality of interconnection portions, wherein each interconnection portion electrically interconnects at least two electrodes in a respective conductive row.

18. The patterned substrate of claim 17, wherein each associated transparent non-conductive and conductive portion comprises an “isolation region,” wherein each interconnection portion is deposited over the transparent non-conductive portion of one of the isolation regions.

19. The patterned substrate of claim 16, wherein each associated transparent non-conductive and conductive portion comprises an “isolation region,” wherein each of the electrodes of the plurality of conductive columns comprises at least one contact portion, and wherein the at least one contact portion is deposited over the transparent conductive portion of one of the isolation regions.

20. The patterned substrate of claim 19, wherein the at least one contact portion is deposited over the transparent non-conductive portion of the one of the isolation regions.

21. The patterned substrate of claim 16, further comprising:
a plurality of traces disposed on the base substrate that are each electrically coupled to one or more of the electrodes.

22. The patterned substrate of claim 21, further comprising:
a connecter that is electrically coupled to the plurality of traces.

23. The patterned substrate of claim 16, wherein the electrodes of the plurality of conductive rows and the electrodes of the plurality of conductive columns at least generally reside in a single plane.

24. The patterned substrate of claim 23, further comprising:
a plurality of traces disposed on the base substrate, wherein at least some of the traces are each electrically coupled to one or more of the electrodes of the plurality of conductive rows, wherein at least some of the traces are each electrically coupled to one or more of the electrodes of the plurality of conductive columns, and wherein the some of the traces electrically coupled to one or more of the electrodes of the plurality of conductive rows and plurality of conductive columns at least generally reside in the single plane.

25. The patterned substrate of claim 15, wherein the plurality of conductive rows are not in contact with the plurality of conductive columns or the plurality of transparent conductive portions.

26. A method for manufacturing a substrate for a touch screen sensor assembly, the method comprising:
providing a base substrate;
forming a plurality of transparent conductive portions on a first side of the base substrate;
forming a plurality of transparent non-conductive portions on the plurality of transparent conductive portions such that each transparent non-conductive portion is deposited over a portion of one of the plurality of transparent conductive portions; and
forming a grid over the base substrate and the plurality of transparent conductive and non-conductive portions, the grid comprising a plurality of conductive rows and a plurality of conductive columns, wherein each conductive row is in contact with at least one of the transparent non-conductive portions and each conductive column is in contact with at least one of the transparent conductive portions, and wherein the plurality of conductive rows are electrically isolated from the plurality of conductive columns by the plurality of transparent non-conductive portions.

27. The method of claim 26, wherein at least one of the forming a plurality of transparent conductive portions, forming a plurality of transparent non-conductive portions, and forming a grid steps comprises:
depositing a layer over the base substrate; and
removing portions of the layer from the base substrate to form the at least one of the plurality of transparent conductive portions, plurality of transparent non-conductive portions, and grid.

28. The method of claim 26, further comprising:
depositing a plurality of traces on the base substrate, wherein each of the plurality of traces is electrically coupled to at least one of the plurality of conductive rows and plurality of conductive rows.

29. The method of claim 28, further comprising:
coating a protective layer over the grid.

30. The method of claim 28, further comprising:
bonding a connector to the plurality of traces.

31. The method of claim 26, wherein the plurality of conductive rows are not in contact with the plurality of conductive columns or the plurality of transparent conductive portions.

32. A patterned substrate for a touch screen sensor assembly, the patterned substrate comprising:
a base substrate;
at least one row of electrodes deposited over a first side of the base substrate, wherein adjacent electrodes in the at least one row of electrodes are interconnected by a leg portion;
at least one column of electrodes deposited over the first side of the base substrate; and
a transparent non-conductive layer disposed between the base substrate and at least one of the at least one row of electrodes and the at least one column of electrodes; wherein the at least one row of electrodes is electrically isolated from the at least one column of electrodes.

33. The patterned substrate of claim 32, wherein the at least one row of electrodes generally resides in a first plane and the at least one column of electrodes generally resides in a second plane different from the first plane.

34. The patterned substrate of claim 33, wherein the transparent non-conductive layer generally resides in a third plane that is disposed between the first and second planes.

35. The patterned substrate of claim 32, wherein the at least one row of electrodes and the at least one column of electrodes generally reside in a single plane.

36. The patterned substrate of claim 32, wherein the transparent non-conductive layer is disposed between the base substrate and the leg portion of adjacent electrodes in the at least one row of electrodes.

37. The patterned substrate of claim 36, further comprising a transparent conductive layer disposed between the transparent non-conductive layer and the base substrate.

38. The patterned substrate of claim 37, wherein adjacent electrodes in the at least one column of electrodes are electrically interconnected to the transparent conductive layer.

39. The patterned substrate of claim 38, wherein the adjacent electrodes in the at least one column of electrodes are in contact with the transparent non-conductive layer.
